(19) United States
(12) Patent Application Publication
(10) Pub. No.: US 2008/0222846 A1
(43) Pub. Date: Sep. 18, 2008

(54) Ergonomic Utensil

(76) Inventors: Hakan Kronogard, Lund (SE); Staffan Norberg, Alvsjo (SE)

Correspondence Address: BROOKS KUSHMAN P.C., 1000 TOWN CENTER, TWENTY-SECOND FLOOR, SOUTHFIELD, MI, 48075, US

(21) Appl. No.: 11/994,335

(22) PCT Filed: Jun. 30, 2006
(86) PCT No.: PCT/SE06/00821

§ 371 Date: Dec. 30, 2007

(30) Foreign Application Priority Data
Jun. 30, 2005 (SE) 0501519-3

(51) Int. Cl. B25G 1/10; B25G 1/06; B65D 25/28

(52) U.S. Cl. 16/430; 16/110.1

(57) ABSTRACT

A utensil comprising a shaft and an operative unit (101), the shaft having a first shaft member (102), where the operative unit (101) is attached, and a second shaft member (103) for being held by a user, the shaft members being joined by a pivotal connection. The assembly of the first shaft member (102) and the operative unit is configured to have a center of gravity, which is substantially directly below the pivotal connection (104), in a work position of the utensil.

### FIELD OF THE INVENTION

The present invention relates to an ergonomic utensil and in particular an ergonomic utensil for domestic and professional use.

### BACKGROUND OF THE INVENTION

Different kinds of cleaning utensils are used in the household and by professional cleaning services. Dustpans e.g. are used for collecting debris and dirt when sweeping. Different dustpans are previously known but they are not optimal for the user from an ergonomical point of view. One previously known dustpan comprises a generally horizontal pan with upwardly projecting side and back walls and a shaft, which is substantially vertical and is equipped with a handle that may be fixed at an angle. Once the dustpan is filled with dirt it is lifted up to the trash bag in order to empty the pan. This may be quite high resulting in an inconvenient working position. There may also be a problem when a dustpan is to be emptied in a wastebasket inside a kitchen cabinet that e.g. is mounted under a sink. Another previously known dustpan is designed with a pivoting pan, which may be equipped with a retractable lid, a so called lobby dustpan, which is intended for both domestic and professional use. The lobby dustpan has a large storage capacity, which can be 1 liter or more. The emptying procedure requires the same type of lift as the first dustpan, and the pivoting pan may counteract the emptying action. The lobby dustpan is also bulky and heavy.

Another type of cleaning utensil is the broom, which is often used in combination with a dustpan of the above described type. A broom is mainly manufactured with a rigid shaft having a head rigidly attached thereon. This is often no problem when sweeping on the floor, but may prove to be a disadvantage when sweeping is required at higher positions, such as on a table or even on top of a bookshelf. Prior art brooms cannot easily be used for these applications, and a ladder and a small, handheld broom must be used for elevated places.

### SUMMARY OF THE INVENTION

It is an object of the present invention to provide an ergonomic utensil, such as a dustpan or a broom, for domestic and professional use.

In an aspect, there is provided an ergonomic utensil comprising a shaft and an operative unit, the shaft having a first shaft member, where the operative unit is attached, and a second shaft member for being held by a user, the shaft members being joined by a pivotal connection. The assembly of the first shaft member and the operative unit is configured to have a center of gravity which is substantially directly below the pivotal connection, in a work position of the utensil. When the second shaft member is pivoted, such that the end being connected to the pivotal connection is raised/lowered, the operative unit will be raised/lowered while maintaining its working position. This is beneficial for working with the utensil at different heights.

In a further aspect of the invention, the operative unit of the utensil is a pan of a dustpan. In a yet further aspect of the invention, the operative unit is a broom head of a broom.

In another aspect of the invention, a method is provided for operating the above utensil. The method of operating the utensil comprises the steps of holding the utensil in a first working position, where the center of gravity of the first shaft member and the operative unit is substantially directly below the pivotal connection, raising/lowering the operative unit by pivoting the second shaft member until the operative unit is in a second working position, while the operative unit maintains an orientation with the center of gravity of the first shaft member and operative unit below the pivotal connection, in order to enable the operative unit to be operated at different heights. In other aspects of the above method according to the invention, there are steps provided for releasing a holding means of the pivotal connection, before raising/lowering the operative unit, and for locking a holding means of the pivotal connection, after the operative unit has been raised/lowered to the second working position.

Further aspects are defined in the dependent claims.

### BRIEF DESCRIPTION OF THE DRAWINGS

Further objects, features and advantages will appear from the description of exemplifying embodiments of the invention with reference to the accompanying drawings, in which:

FIG. 1 is a schematic side view of a previously known dustpan;

FIG. 2 is a perspective view of another prior art dustpans;

FIG. 3 is a side view of an embodiment of a dustpan according to the invention in a working position;

FIG. 4 is a side view of the embodiment of FIG. 3 in an emptying position,

FIGS. 5a and 5b are partial side views in enlarged scale of different holding devices for the utensil of the invention,

FIG. 6 is a side view of a broom arranged according to the invention; and

FIG. 7 is a side view showing the broom of FIG. 6 in working positions at different elevations.

### DETAILED DESCRIPTION OF PREFERRED EMBODIMENTS

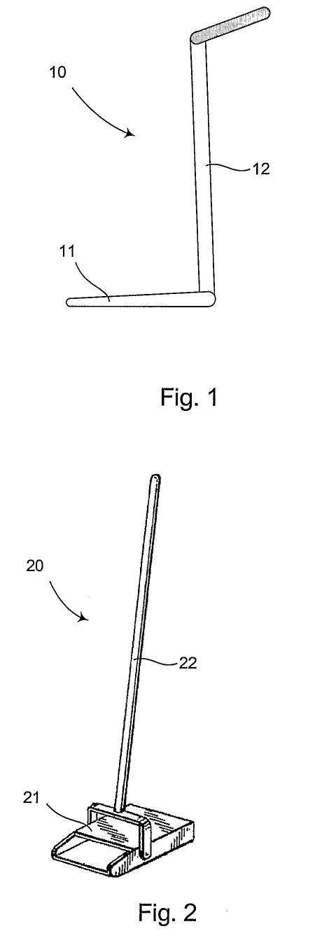

FIG. 1 schematically discloses a previously known dustpan 10 having a generally horizontal pan 11 with upwardly projecting side and back walls. Moreover, the dustpan 10 comprises a shaft 12, which is substantially vertical and is ended with a handle that may be rigidly fixed at an angle. The dustpan 10 operates well during use, but is inconvenient to handle during emptying into a trash bag.

FIG. 2 discloses another type of dustpan, the so-called lobby dustpan 20. The lobby dustpan comprises a boxlike dust-collecting tray 21 enclosing a space, which is open at one end, where dust is pushed into the tray 21. The tray is supported by a shaft 22, which is pivotally connected to the tray at one end, as shown in FIG. 2. Such pivotal connection makes it difficult to empty the tray. However, the tray may be large so that the dustpan does not need to be emptied often.

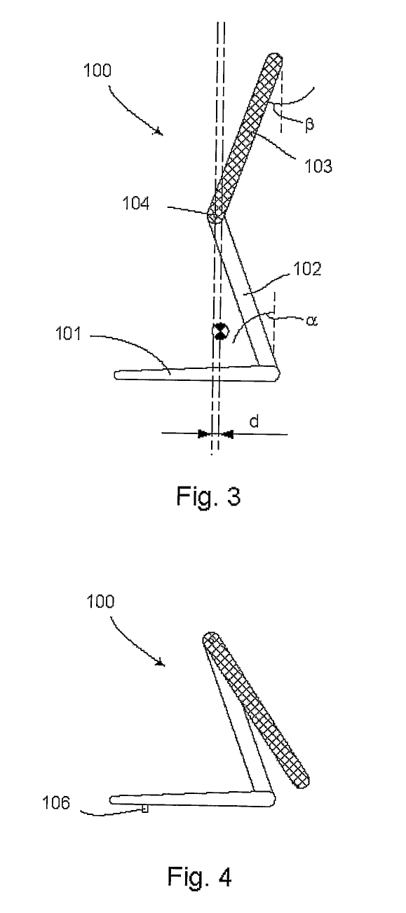

FIG. 3 schematically shows a dustpan 100 having an ergonomic shaft according to the invention. The dustpan comprises a pan 101, a first shaft member 102, a second shaft member 103 and a pivot pin 104, interconnecting the first 102 and the second 103 shaft members. The pan may be of any design, such as a box or a pan provided with side edges at three sides.

The first shaft member 102 is joined to the pan 101 with a substantially rigid connection. The first shaft member is formed so that its upper part is positioned generally over the pan, which is indicated by the first shaft member being inclined over the pan at an angle, α, to a vertical line.

The first or the second shaft member may have a length, which is 20 to 80% of the length of the overall shaft.

A lower end of the second shaft member 103 is pivotally connected to the upper end of the first member 102 by means of said pivot pin 104. The second shaft member 103 may be inclined in the other direction compared to the first shaft member, forming an angle, β, to a vertical line, as shown in FIG. 3. The angle between the first 102 and second 103 shaft members is then given by 180°-(α+β), and this angle can be between 0° and 180°, i.e. may also form a straight shaft. A change of this angle also results in a raising or lowering of the handle portion, i.e. the upper part of the second shaft member 103, and this can be used to adapt the shaft for different users.

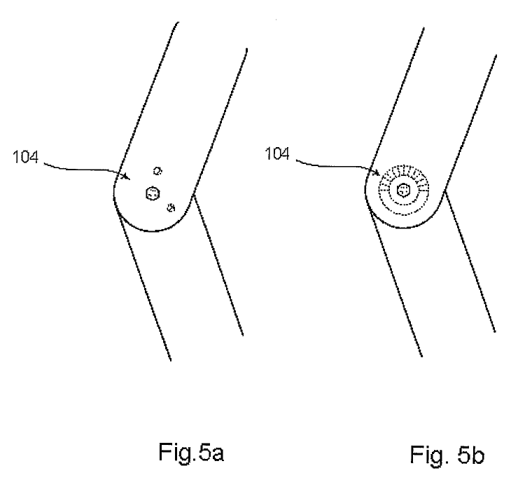

The free pivotal movement between the first 102 and second 103 shaft members may be restricted by a releasable holding device. In an embodiment, this holding device comprises at least one permanent magnet arranged in one of the shaft members 102, 103 and a co-acting ferromagnetic unit in the other of the shaft members 103, 102. This magnetic assembly is arranged to quasi-statically hold the shaft members 102, 103 in a preferred working position, e.g. as shown in FIG. 3. The holding force should be sufficiently large to enable normal sweeping and collecting, but be sufficiently small to be releasable by applying a substantial torque around the pivot pin 104. After the release, the rotation is more or less free. The holding device may comprise an additional magnetic assembly of the above kind, for holding the two shaft members 102, 103 in an emptying position, as shown in FIG. 4. This type of holding device can be seen in FIG. 5a.

The holding device may be any form of quasi-static device, having at least one restricted position, which device is releasable in order to fold the shaft, i.e. pivot the second shaft member 102 in relation to the first 103. Another embodiment of the holding device may be a biased ball residing in a small hole, which ball at rotation rolls in a circular groove. Another alternative embodiment is a ridge residing in a groove, and this can be seen in FIG. 5b. A further alternative embodiment is to use different materials, one material with a high friction coefficient and one slick material. When portions of the assembly having high-friction material are facing each other, a locking function is obtained, and as soon as the shaft is rotated, the slick material will enable rotation or at least make rotation easier.

The pivotal connection may also be formed without any form of holding device. In this case, the downwardly facing surface of the pan 101 may comprise a high-friction material. The pivotal connection may alternatively be formed with a constant friction in the pivotal connection which enables the dustpan to be used for collecting debris, but still makes it possible to fold the shaft as is shown in FIG. 4 by using a substantial force. The friction may be relatively low such as within the range 0.1-0.3.

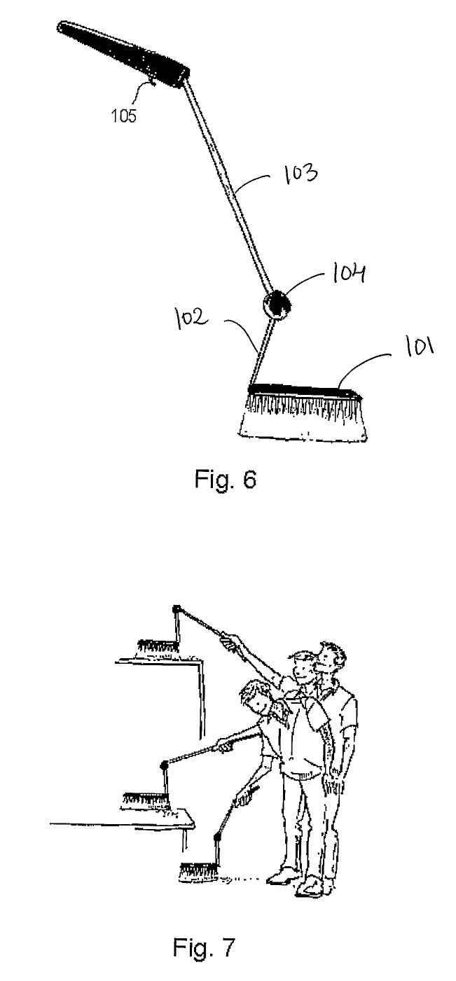

The shaft may also be provided with a trigger 105 for releasing and engaging the holding device, see FIG. 6. This trigger 105 can be mounted at the handle for enabling a quick release.

In another embodiment, the second shaft member 103 has an angle (β) to a vertical that makes it suitable for being used as a handle. In this way, the hand of a user can be placed anywhere along the second shaft member 103, which makes it suitable for people of different heights and having different arm lengths. For this reason, the entire surface of the second shaft member 103 may be provided with a gripping material along a substantial length of the second shaft member, such as a coating or a soft covering for making it comfortable to grip and use. Alternatively, the second shaft member is formed with an adjustable handle, or is formed with a shape that suits the hand.

The center of gravity of the assembly of the pan 101 and the first shaft member 102 is indicated by a circular symbol in FIG. 3. In a first case, this center could be located vertically below the pivot 104, or, in a second case, slightly offset a distance d towards the shaft. In the first case, if the pivotal connection allows free rotation, said assembly will not rotate at all during rotation of the second shaft member 103, because the assembly simply hangs balanced in the pivotal connection. In the second case, said assembly will rotate clockwise in the figure. The collected debris will then remain in the pan 101 during rotation of the second shaft member 103 during raising of the pan up to the wastebasket. The distance d should be chosen so that the rotation of the pan-shaft assembly is no more than about 5 degrees. A negative distance d may be present as long as the consequent anti-clockwise rotation is kept small, e.g. less than 2 degrees.

The pan 101 may be releasably secured to the first shaft member 102, in order to make the dustpan less space consuming, both during transport and storage, either with a releasable pivot or with a releasable coupling.

The ergonomic utensil according to the invention can also incorporate a broom head, as can be seen in FIG. 6. The lower part of the broom comprising the broom head and the first shaft member 102 may also be arranged with its center of gravity being substantially vertically below the joint in a working position of the broom. The broom according to the invention will facilitate cleaning of elevated surfaces, such as on tables or on top of bookcases, as shown in FIG. 7.

The dustpan of the present invention is used for collecting debris, and is then used in the configuration shown in FIG. 3.

When the dustpan is to be emptied, the user first releases any optional holding device of the pivotal connection, and then rotates the second shaft member 103 to the position shown in FIG. 4, without lowering or raising his/her hand, as explained below. The rotation of the second shaft member 103 about the users hand, being placed somewhere upwards of the pivot 104, lifts the pivot 104 which in turn lifts the first shaft member 102 with the pan 101. The pan 101 is now lifted substantially from the floor, and is preferably above the upper rim of the trash bag. The first shaft member 102 should now be restricted from pivoting when the dustpan is emptied, and this can be done in various ways. The first shaft member can either be held in a folded position, as seen in FIG. 4, by a holding device of the type mentioned above, or the pan 101 may be formed with a protrusion 106 that is held against the wastebasket.

The user then rotates the second shaft member 103 in the reverse direction and the pan 101 is returned to the floor. The optional holding device may now be re-engaged manually or automatically.

The broom is used in a similar fashion, where the angle between the two parts is changed in order to work at a specific elevation, see FIG. 7.

The utensil of the present invention comprises a shaft and an operative unit 101, such as a pan of a dustpan, a broom head of a broom, a head of a cheese slicer or similar. The first shaft member 102 and the operative unit 101 forms a lower assembly, which has a center of gravity that is substantially directly below the pivotal connection 104, in a work position of the utensil. This will make the lower assembly freely pivotable when the pivotal connection 104 is unrestricted. The location of the center of gravity, substantially directly below the pivotal connection 104, will make the assembly of the operative unit 101 and the first shaft member 102 maintain an orientation that matches that of the work position. In the case of the dustpan, the pan 101 will remain substantially horizontal, despite rotation of the second shaft member 103, and the debris will remain inside the pan 101 of the dustpan. This will simplify emptying of the dustpan in a trash bag. In the case of the broom, the broom head will maintain a horizontally oriented bottom surface when the second shaft member is rotated and the pivotal connection is released. This will make it possible to raise the broom head to the top of a desk or bookcase, and sweep a top surface of said desk or bookcase. The broom head will remain horizontal during the raising of the broom and this will simplify sweeping at elevated positions.

The pivotal connection 104 is shown as a knee joint, but a ball joint or similar is also feasible.

Even though detailed embodiments of the invention have been described above, it will be evident for a person skilled in the art that various modifications and alterations can be made without departing from the scope of the invention as given by the appended claims.

1. A utensil comprising a shaft and an operative unit, the shaft having a first shaft member, where the operative unit is attached, and a second shaft member for being held by a user, the shaft members being joined by a pivotal connection, characterized in that the assembly of the first shaft member and the operative unit is configured to have a center of gravity which is substantially directly below the pivotal connection, in a work position of the utensil.

2. A utensil according to claim 1, wherein the pivotal connection comprises a releasable holding device for holding the first and the second shaft members fixed at a relative angle.

3. A utensil according to claim 2, wherein a trigger is arranged at the handle for engaging and/or disengaging the releasable holding device.

4. A utensil according to claim 2, wherein the holding device comprises a permanent magnet connected to one of the shaft members and a part of ferromagnetic material connected to the other shaft member and co-operating with said magnet.

5. A utensil according to claim 4, wherein the holding device comprises at least two magnets in one of the shaft members and at least two parts of ferromagnetic material in the other shaft member and co-operating with said at least two magnets, for obtaining at least two holding positions.

6. A utensil according to claim 2, wherein the holding device comprises interacting parts comprising ridges and grooves.

7. A utensil according to claim 1, wherein the pivotal connection is designed to have a friction coefficient between the first and second shaft members in the range of 0.0 to 0.3.

8. A utensil according to claim 1, wherein a length of the first shaft member is 20-80% of the length of the overall shaft.

9. A utensil according to claim 1, wherein a length of the second shaft member is 20-80% of the length of the overall shaft.

10. A utensil according to claim 1, wherein the second shaft member is provided with a gripping material along a substantial part of its length.

11. A utensil according to claim 1, wherein the operative unit is releasably secured to the first shaft member via a releasable coupling or releasable pivot.

12. A utensil according to claim 1, wherein at least a portion of the first shaft member is integrated with the operative unit.

13. A utensil according to claim 1, wherein the operative unit is a pan of a dustpan.

14. A utensil according to claim 13, wherein the center of gravity for the pan and first shaft member assembly is offset slightly towards the first shaft member compared to a vertical line from the pivotal connection.

15. A utensil according to claim 13, wherein the pan is formed with a downwardly extending protrusion.

16. A utensil according to claim 13, wherein the pan is formed with a high-friction material on the downwardly facing side.

17. A utensil according to claim 1, wherein the operative unit is a broom head.

18. A method of operating a utensil, the method comprising the steps of holding the utensil in a first working position, where the center of gravity of the first shaft member and the operative unit is substantially directly below the pivotal connection, raising/lowering the operative unit by pivoting the second shaft member until the operative unit is in a second working position, while the operative unit maintains an orientation with the center of gravity below the pivotal connection, in order to enable the operative unit to be operated at a different height.

19. A method according to claim 18, comprising the additional step of releasing a holding means of the pivotal connection, before raising/lowering the operative unit.

20. A method according to claim 18, comprising the additional step of locking a holding means of the pivotal connection, after the operative unit has been raised/-lowered to the second working position.
